(19) United States
(12) Patent Application Publication
(10) Pub. No.: US 2004/0062908 A1
(43) Pub. Date: Apr. 1, 2004

(54) Thermoplastic sandwich structural item and twin sheet moulding method of making same

(75) Inventor: Dick T. Van Manen, Canandaigua, NY (US)

Correspondence Address: MCDONNELL BOEHNEN HULBERT & BERGHOFF, 300 SOUTH WACKER DRIVE, SUITE 3200, CHICAGO, IL, 60606, US

(73) Assignee: Meridian Automotive Systems, Inc.

(21) Appl. No.: 10/665,649

(22) Filed: Sep. 19, 2003

Related U.S. Application Data
(62) Division of application No. 10/161,202, filed on Jun. 3, 2002, now abandoned.
(60) Provisional application No. 60/295,113, filed on Jun. 1, 2001.

(51) Int. Cl. B32B 3/12

(52) U.S. Cl. 428/116

(57) ABSTRACT

A method for molding panels in a sheet molding system comprised of a thermoplastic sheet delivery station and two mold halves, the method comprising the steps of delivering two sheeting layers of thermoplastic material between the two mold halves; inserting a rigidizing insert between the two sheeting layers of thermoplastic material; closing the mold halves to bring the two sheeting layers of thermoplastic material in contact with the insert; and compressing the thermoplastic sandwich between the mold halves to form a panel. A thermoplastic-insert sandwich and a laminate panel comprised of thermoplastic layers abutting a pre-manufactured insert are also claimed.

### BACKGROUND OF THE INVENTION

The present invention relates to a method of manufacturing thermoplastic panels for automotive and other uses. This application claims priority of U.S. patent application Ser. No. 60/295,113.

Various types of automotive panels, including interior panels such as rear shelf panels, inner door panels, etc., are usually either molded in a single layer with ribs or are assembled to a second layer to gain structural strength and/or acoustic properties desired. Typical layers may include a relatively rigid panel for strength, a decorative layer (with a carpeting, fabric or vinyl exposed surface), a core panel of foam or other light weight construction to help with rigidizing and/or soundproofing, a back panel for added sound-proofing, and a barrier sandwich.

These panels are typically formed by injection molding a thermoplastic material directly into a mold. The mold also can contain one or more layers of other laminate materials, such as a decorative layer. The mold is then closed, distributing the thermoplastic material throughout the available space in the cavity, forming the panel. Where additional layers are included, the mold laminates the layers.

The present invention relates to a method of manufacturing automotive panels and more particularly relates to a method of making thermoplastic panels.

Various types of automotive panels, including interior panels such as rear shelf panels, inner door panels, etc., are usually either molded in a single layer with ribs or are assembled to a second layer to gain structural strength and/or acoustic properties desired. For interior trim panels, typical layers may include a relatively rigid panel for strength, a decorative layer (with a carpeting, fabric or vinyl exposed surface), a foam core panel for added sound-proofing, and a barrier sandwich.

These panels are typically formed by injection molding a thermoplastic material directly into a mold or by sheet molding, which comprises inserting previously-manufactured sheeting of thermoplastic material into a mold. The mold also can contain one or more layers of other laminate materials, such as a decorative layer. Once the sheeting of material are placed in the mold the mold is then closed, distributing the thermoplastic material throughout the contours of the cavity, and thus forming the panel. Where an additional layer is included, such as a decorative layer, it is typically laminated to the thermoplastic material as part of the molding process. Vacuum forming may also be used to assist the molding process.

With these types of molding processes, a recurring problem is how to provide a laminate strong enough to be used as load floors or other panels that require enhanced rigidity and how to assemble such laminates in an economical and efficient manner. It is an object of this invention, therefore, to provide a laminate that exhibits greater rigidity with minimal or no use of adhesives. It is a further object of this invention to provide a process that permits the manufacture of such laminates with the excessive use of adhesives.

### SUMMARY OF THE INVENTION

Laminate panels are made using two layers of thermoplastic material which are dispensed vertically coming down from a thermoplastic material delivery station. The two separate sheeting which may be the same or different resins, but must be thermoplastic and capable of being bonded together either by heat alone or by adhesives on an insert. A rigidizing insert, comprising, for example, structural foam, compatible thermoplastic foam, thermoplastic honeycomb core or soundproofing/acoustic foam, is inserted between the two sheeting layers to form a multi-layer laminate.

Typical target parts to be made with the process of the present invention are: rear shelf trim panels; load floors; spare tire covers; and knee bolsters, although the invention is not limited to these products.

### BRIEF DESCRIPTION OF THE DRAWINGS

FIG. 1 is a side view of the sheet molding system of the present invention.

FIG. 2 is a cross-sectional view of a panel made using the sheet molding system described herein.

### DESCRIPTION OF THE PREFERRED EMBODIMENT

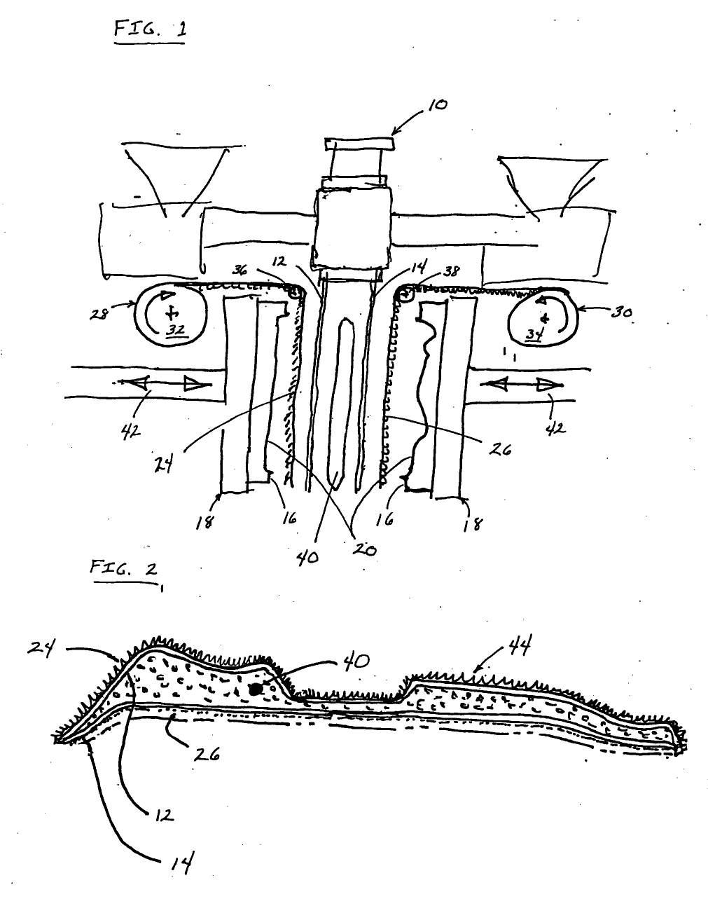

This process is illustrated in FIG. 1. The sheet molding system of the present invention includes a hot thermoplastic sheet material delivery station 10, aligned to deliver two or more heated thermoplastic sheeting layers 12, 14 vertically downward between mold faces 16 and 18. Mold faces 16, 18 have depressions 20 which, when they abut, form a cavity with contours in the shape of the part that is to be formed by the sheet molding system.

In a preferred embodiment, the thermoplastic sheet delivery station 10 includes an extruder 22 which dispenses hot sheeting layers of thermoplastic sheet material 12, 14 in front of mold faces 16 in mold halves 18. To form such sheet material, the thermoplastic material may be calendared through hot rollers producing sheeting layers, and through additional hot rollers to produce the desired thickness. Alternatively, the thermoplastic sheet delivery station 10 can deliver other types of thermoplastic sheet materials, such as a heated flax/polypropylene moldable mat, as one or more thermoplastic sheeting layer(s) of part construction, dependent solely upon design preferences. Such flax/polypropylene mats are described in U.S. Pat. No. 5,614,285. In this case, the hot thermoplastic sheet delivery station 19 can comprise a flax/polypropylene mat unroller, with heated rollers or hot plates heating the mat to an appropriate temperature before the mat sheeting layers enter the space between mold faces 16.

If desired, surface covering material(s) 24, 26 can be dispensed from insert or roller systems 28, 30 comprising surface covering material unroll station(s) 32, 34 and rollers 36, 38. The insert or roller systems 28, 30 dispense the surface covering material 24, 26 so as to interpose the surface covering material 24, 26 between the sheeting layer(s) 12, 14 and their respective mold faces 16. Where a surface covering material is used, the desired side(s) of the surface covering material for ultimate part appearance or performance objectives on the front or back of the part or both is oriented facing the mold face 16.

A rigidizing insert 40 is inserted between the thermoplastic sheeting layers 12, 14, and may be pre-coated with adhesives if needed to cause bonding between the thermoplastic layers of the sandwich. The rigidizing insert 40 may assist in rigidizing the formed part, may be compatible to the thermoplastic material, and can be lightweight and fusable. Exemplary rigidizing inserts include structural foam, compatible thermoplastic foam, thermoplastic honeycomb core or soundproofing/acoustic foam. The rigidizing insert may be inserted from the front or back of the machine on a reciprocating rack with pins that hold the insert in place between the thermoplastic sheeting layers. The rigidizing insert included any pre-manufactured inserts, including flat-slabbed blanks, partially-shaped blanks, or pre-molded inserts.

After the rigidizing insert 40 is inserted between layers of thermoplastic sheeting layers 12, 14 and the optional surface covering material 24, 26, mold halves 18 are forced together by pistons 42. As the mold halves 18 close together, they press the thermoplastic sheeting layers 12, 14, the rigidizing insert 40, and any optional surface covering materials 24, 26 together to form a thermoplastic-insert sandwich.

As the mold halves 18 close together fully the mold faces 16 force the thermoplastic sheeting layers and, optionally, to a certain extent, the insert 40 to move with any covering material into contact with the molds. Thereafter, the molded laminate cools, rigidizing to form a part. A vacuum may be drawn in one or both halves during the molding process to assist in distribution of the thermoplastic-insert sandwich. If any insert used stays inside the periphery joint of bondable compatible thermoplastic layers, the part will have a strong bond at the periphery, just as if no insert was used. Inserts 40 which protrude outside the joint area must be treated to allow the joint area bond to still develop.

Cooling of parts made in this manner may require acceleration through the use of refrigerated air or nitrogen or carbon dioxide gas to be supplied to the outside surfaces of the part through vents in the mold halves 18.

As shown in FIG. 2, the novel laminate panel 44 made using this system comprises at least two thermoplastic layers 12, 14, the insert 40, and one or more optional surface covering layers 24, 26. The exposed surfaces of the molded thermoplastic layers 12, 14 or optional surface covering layers 24, 26 conform generally to the depressions 20 in mold faces 16. Exemplary surface covering layers include carpeting (e.g., for exposed automotive interior panels) and sound absorbers or barriers.

Using a dual clamp type machine with sheeting layers being dispensed to the two clamps in alternating sequence using a three minute overall cycle, it is estimated that 40 parts per hour could be made by two operators and a $1.5 million investment.

Trim of thermoplastic compatible ingredients could be round and blended back in at least one layer of the parts, keeping material costs low in comparison to other processes using mats or purchased sheets.

The present invention is not limited to interior trim panels, but can be applied equally well to any other types of panels, such as other automotive panels and to non-automotive applications in the office furniture and building trade.

Preferred embodiments of the present invention have been described herein. It is to be understood that modifications and changes can be made without departing from the true scope and spirit of the invention, as defined by the following claims which are to be interpreted and understood in view of the foregoing.

I claim:

1. A method for molding panels in a sheet molding system comprised of a thermoplastic sheet delivery station and two mold halves, the method comprising the steps of
(a) delivering two sheeting layers of thermoplastic material between the two mold halves;
(b) inserting a rigidizing insert between the two sheeting layers of thermoplastic material;
(c) closing the mold halves to bring the two sheeting layers of thermoplastic material in contact with the insert; and
(d) compressing the thermoplastic sandwich between the mold halves to form a panel.

2. The method of claim 1 wherein at least part of the thermoplastic sheet delivery system is disposed vertically above the mold halves.

3. The method of claim 1 wherein the thermoplastic sheet delivery system delivers at least two sheeting layers of thermoplastic material between the two mold halves downward from a position vertically above the mold halves.

4. The method of claim 1 wherein closing the mold halves to bring the two sheeting layers of thermoplastic material in contact with the insert forms a thermoplastic-insert sandwich.

5. The methods of claim 1 wherein the thermoplastic sheet delivery station comprises one or more extruders.

6. The method of claim 5 wherein the thermoplastic sheet delivery station also comprises one or more pair of calendaring rollers.

7. The method of claim 1 wherein the thermoplastic sheet is a flax/polypropylene sheet.

8. The method of claim 1, further comprising the steps of delivering a layer of surface covering material to at least one mold half.

9. The method of claim 8, wherein the surface covering material is comprised of carpeting.

10. The method of claim 9, wherein the surface covering material is delivered to the mold half which forms a top side of the part formed.

11. The method of claim 1, wherein the thermoplastic sheeting layers delivered to both mold halves are comprised of the same thermoplastic material.

12. The method of claim 1, wherein the thermoplastic sheeting layers delivered to the mold halves are comprised of different thermoplastic material.

13. A thermoplastic-insert sandwich comprising at least two layers of thermoplastic sheeting layers abutting at least two sides of a pre-manufactured, rigidizing insert.

14. The thermoplastic-insert sandwich of claim 13 wherein the rigidizing insert is comprised of foam core material.

15. The thermoplastic-insert sandwich of claim 13 wherein the rigidizing insert is comprised of structural foam.

16. The thermoplastic-insert sandwich of claim 13 wherein the rigidizing insert is comprised of compatible thermoplastic foam.

17. The thermoplastic-insert sandwich of claim 13 wherein the rigidizing insert is comprised of thermoplastic honeycomb core material.

18. The thermoplastic-insert sandwich of claim 13 wherein the rigidizing insert is comprised of soundproofing/acoustic foam.

19. The thermoplastic sandwich of claim 13, further comprising a layer of decorative material.

20. The thermoplastic-insert sandwich of claim 13 or 19 wherein the sandwich is essentially free of any adhesive material.

21. A laminate panel comprised of two or more molded layers of thermoplastic sheeting layers abutting a pre-manufactured insert.

22. The laminate panel of claim 21 wherein the panel is essentially free of any adhesive material.

23. The laminate panel of claim 21 wherein the thermoplastic sheeting layers are thermoplastically bonded to the insert.

24. The laminate panel of claim 21 wherein the insert assists in rigidizing the panel.

25. The laminate panel of claim 21 wherein the rigidizing insert is comprised of foam core material.

26. The laminate panel of claim 21 wherein the rigidizing insert is comprised of structural foam.

27. The laminate panel of claim 21 wherein the rigidizing insert is comprised of compatible thermoplastic foam.

28. The laminate panel of claim 21 wherein the rigidizing insert is comprised of thermoplastic honeycomb core material.

29. The laminate panel of claim 21 wherein the rigidizing insert is comprised of soundproofing or acoustic foam.

30. The laminate panel of claim 21 or 22 wherein the laminate panel is an automotive trim panel.

31. The laminate panel of claim 30 wherein the laminate panel is further comprised of a decorative layer.
